(19) United States
(12) Patent Application Publication
(10) Pub. No.: US 2022/0176982 A1
(43) Pub. Date: Jun. 9, 2022

(54) VEHICLE CONTROL APPARATUS

(71) Applicant: TOYOTA JIDOSHA KABUSHIKI KAISHA, Toyota-shi (JP)

(72) Inventors: Mafune KAKESHITA, Toyota-shi (JP); Toshifumi KAWASAKI, Toyota-shi (JP)

(73) Assignee: TOYOTA JIDOSHA KABUSHIKI KAISHA, Toyota-shi (JP)

(21) Appl. No.: 17/489,929

(22) Filed: Sep. 30, 2021

(30) Foreign Application Priority Data
Dec. 8, 2020 (JP) 2020-203385

(51) Int. Cl. B60W 50/12; B60W 30/09

(52) U.S. Cl. CPC B60W 50/12; B60W 30/09; B60W 2420/50; B60W 2540/18; B60W 2420/42; B60W 2540/10

(57) ABSTRACT

A vehicle control apparatus selects a control target object, based on object information and executes a collision avoidance control when a predetermined execution condition is satisfied. The vehicle control apparatus determines that a driver of an own vehicle carries out a first mistaken operation when a predetermined first pressing condition that the driver of the own vehicle strongly operates the acceleration operator, is satisfied, and a magnitude of the steering angle is greater than a predetermined first steering angle threshold, and permits executing the collision avoidance control when a first situation that the driver of the own vehicle carries out the first mistaken operation, and a distance between the own vehicle and the control target object is shorter than a predetermined first distance threshold, arises.

### BACKGROUND

### Field

The invention relates to a vehicle control apparatus which is configured to execute a collision avoidance control.

### Description of the Related Art

There is known a vehicle control apparatus which is configured to detect objects around an own vehicle and execute a collision avoidance control for avoiding a collision of the own vehicle with the objects. The collision avoidance control is also called a pre-crash safety control. Hereinafter, the collision avoidance control will be referred to as “PCS control”.

In a situation that there is an object ahead of the own vehicle, a driver of the own vehicle may carry out driving operations such as an operation to an accelerator pedal of the own vehicle and an operation to a steering wheel of the own vehicle. When the driver carries out such driving operations, the driving operations may be ones for avoiding a collision of the own vehicle with the object. Accordingly, one of the known vehicle control apparatuses executes a control in response to the driving operations carried out by the driver instead of the PCS control. Such a control is also referred to as “override control”.

In this regard, for example, the driver may mistakenly operate an accelerator pedal of the own vehicle instead of a brake pedal of the own vehicle. Hereinafter, such an operation will be referred to as “mistaken operation to the accelerator pedal” or “mistaken operation to the acceleration operator”. An apparatus described in JP 2012-121534 A (hereinafter, this apparatus will be referred to as “conventional apparatus”) determines whether the mistaken operation to the accelerator pedal is carried out. The conventional apparatus executes the PCS control without executing the override control when the conventional apparatus determines that the mistaken operation to the accelerator pedal is carried out.

When the driver operates the steering wheel, such an operation can be considered to be an operation for avoiding the collision of the own vehicle with the object. However, the driver may considerably operate the steering wheel, carrying out the mistaken operation to the accelerator pedal since the driver is panicked. In this situation, if the override control in response to the driving operations carried out by the driver is executed without executing the PCS control, the own vehicle may approach the object around the own vehicle.

### SUMMARY

An object of the invention is to provide a vehicle control apparatus which can execute the PCS control when the driver carries out the mistaken operation to the accelerator pedal and considerably operates the steering wheel.

A vehicle control apparatus according to the invention comprises at least one surrounding sensor, an operation amount sensor, a steering angle sensor, and a control unit. The at least one surrounding sensor acquires object information on objects in a surrounding area around an own vehicle. The operation amount sensor detects an operation amount of an acceleration operator of the own vehicle. The steering angle sensor detects a steering angle of a steering wheel of the own vehicle. The control unit is configured to select a control target object, based on the object information, and execute a collision avoidance control for avoiding a collision of the own vehicle with the control target object when a predetermined execution condition that a probability that the own vehicle collides with the control target object is high, is satisfied.

The control unit determines that a driver of the own vehicle carries out a first mistaken operation when (i) a predetermined first pressing condition that the driver of the own vehicle strongly operates the acceleration operator, is satisfied, and (ii) a magnitude of the steering angle is greater than a predetermined first steering angle threshold. Further, the control unit permits executing the collision avoidance control when a first situation that (i) the driver of the own vehicle carries out the first mistaken operation, and (ii) a distance between the own vehicle and the control target object is shorter than a predetermined first distance threshold, arises.

The vehicle control apparatus according to the invention can execute the collision avoidance control when the first mistaken operation that the driver is panicked and strongly operates the acceleration operator and considerably operates the steering wheel, is carried out. Thus, the own vehicle can be prevented from approaching the object in the surrounding area around the own vehicle.

According to an aspect of the invention, the control unit may be configured to forbid accelerating the own vehicle, based on the operation amount when the first situation arises.

With this aspect of the invention, the own vehicle is not accelerated when the first mistaken operation is carried out. Thus, the own vehicle can be surely prevented from approaching the object in the surrounding area around the own vehicle.

According to another aspect of the invention, the control unit may be configured to determine that the predetermined first pressing condition is satisfied when (i) an operation speed which corresponds to a change amount of the operation amount per unit time is greater than or equal to a predetermined first operation speed threshold, and (ii) the operation amount is greater than or equal to a predetermined first operation amount threshold.

With this aspect of the invention, the vehicle control apparatus can determine whether the driver mistakenly operates the acceleration operator, based on the operation speed and the operation amount.

According to further another aspect of the invention, the at least one surrounding sensor may include a first sensor, and at least one second sensor. The first sensor takes images of a first area around the own vehicle, acquires image data on the taken images, and acquires the object information on the objects in the first area by using the image data. The at least one second sensor which acquires the object information on the objects in a second area around the own vehicle by using electromagnetic waves, the second area including the first area and being wider than the first area. According to this aspect of the invention, the control unit may be configured to select the control target object from among (i) first objects detected by the first sensor and the at least one second sensor and (ii) second objects detected only by the at least one second sensor when the control unit determines that the driver of the own vehicle carries out the first mistaken operation.

When the first mistaken operation is carried out, the own vehicle turns considerably. Accordingly, the vehicle control apparatus according to this aspect of the invention selects the control target object from the wide area. Thereby, the vehicle control apparatus according to this aspect can prevent the own vehicle from approaching the object in the surrounding area around the own vehicle.

According to further another aspect of the invention, the control unit may be configured to determine that the driver of the own vehicle carries out a second mistaken operation when (i) a predetermined second pressing condition that the driver of the own vehicle strongly operates the acceleration operator, is satisfied, and (ii) the magnitude of the steering angle is smaller than a predetermined second steering angle threshold. Further, according to this aspect of the invention, the control unit may be configured to permit executing the collision avoidance control when a second situation that (i) the driver of the own vehicle carries out the second mistaken operation, and (ii) the distance between the own vehicle and the control target object is shorter than a predetermined second distance threshold, arises. Furthermore, according to this aspect of the invention the control unit may be configured to forbid accelerating the own vehicle, based on the operation amount when the first or second situation arises. Furthermore, according to this aspect of the invention, the predetermined first distance threshold is greater than the predetermined second distance threshold.

When the first mistaken operation is carried out, the driver is probably panicked. With this aspect of the invention, the predetermined first distance threshold is greater than the predetermined second distance threshold. Thus, the vehicle control apparatus according to this aspect forbids accelerating the own vehicle and permits executing the collision avoidance control at an earlier timing when the first mistaken operation is carried out, compared with when the second mistaken operation is carried out. On the other hand, when the second mistaken operation is carried out, the driver may intentionally and strongly operate the acceleration operator. Thus, when the second mistaken operation is carried out, the vehicle control apparatus according to this aspect forbids accelerating the own vehicle and permits executing the collision avoidance control at a later timing, compared with when the first mistaken operation is carried out. Thus, the collision avoidance control can be prevented from being executed in an unnecessary situation.

According to further another aspect of the invention, the control unit may be configured to determine that the first pressing condition is satisfied when (i) an operation speed which corresponds to a change amount of the operation amount per unit time is greater than or equal to a predetermined first operation speed threshold, and (ii) the operation amount is greater than or equal to a predetermined first operation amount threshold. Further, according to this aspect of the invention, the control unit may be configured to determine that the second pressing condition is satisfied when (i) the operation speed is greater than or equal to a predetermined second operation speed threshold, and (ii) the operation amount is greater than or equal to a predetermined second operation amount threshold. Furthermore, according to this aspect of the invention, the predetermined first operation amount threshold may be smaller than the predetermined second operation amount threshold.

The operation amount derived from the first mistaken operation is generally smaller than the operation amount derived from the second mistaken operation. Thus, the vehicle control apparatus according to this aspect of the invention can accurately determine whether the first mistaken operation is carried out.

According to further another aspect of the invention, the control unit may be configured to stop executing the collision avoidance control when a steering operation speed which corresponds to a change amount of the steering angle per unit time has been greater than a predetermined first steering operation speed for a predetermined time or more.

When the driver carries out the first mistaken operation, the driver has considerably operated the steering wheel. Thus, the steering operation speed is unlikely to increase. With this aspect of the invention, when the driver carries out the first mistaken operation, the execution of the collision avoidance control is unlikely to be stopped. Thus, the vehicle control apparatus according to this aspect of the invention can prevent the own vehicle from approaching the object in the surrounding area around the own vehicle.

According to one or more embodiments, the control unit may be realized by a micro-processor which is programmed to execute one or more functions described in this description. Further, according to one or more embodiments, the control unit may be totally or partially realized by hardware configured by integrated circuits such as ASIC dedicated to one or more applications.

Elements of the invention are not limited to elements of embodiments and modified examples of the invention described along with the drawings. The other objects, features and accompanied advantages of the invention can be easily understood from the embodiments and the modified examples of the invention.

### BRIEF DESCRIPTION OF THE DRAWINGS

FIG. 1 is a general configuration view which shows a vehicle control apparatus according to one or more embodiments of the invention.

FIG. 2 is a view which describes object information such as a longitudinal distance between an own vehicle and an object and an orientation of the object with respect to the own vehicle acquired by surrounding sensors shown in FIG. 1.

FIG. 3 is a view which shows detection areas of radar sensors and a camera sensor shown in FIG. 1.

FIG. 4 is a view which shows a flowchart of a first flag setting routine executed by a CPU of a collision avoidance ECU or PCS ECU.

FIG. 5 is a view which shows a flowchart of a first mistaken operation determining routine executed by the CPU at a step 403 of the routine shown in FIG. 4.

FIG. 6 is a view which shows a flowchart of a second mistaken operation determining routine executed by the CPU at a step 404 of the routine shown in FIG. 4.

FIG. 7 is a view which shows a flowchart of a PCS control executing routine executed by the CPU.

FIG. 8 is a view which shows a flowchart of a PCS control stopping routine executed by the CPU.

FIG. 9 is a view which shows a flowchart of the first flag setting routine executed by the CPU according to a modified example.

### DESCRIPTION OF THE EMBODIMENTS

<Configuration of Vehicle Control Apparatus>

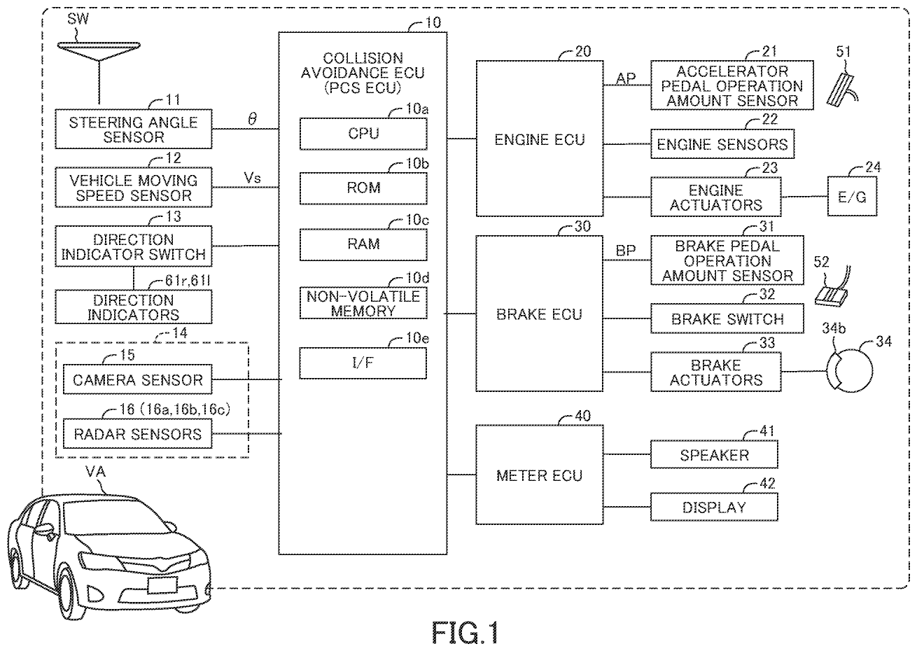

As shown in FIG. 1, a vehicle control apparatus according to one or more embodiments of the invention is applied to an own vehicle VA. The vehicle control apparatus includes a collision avoidance ECU 10, an engine ECU 20, a brake ECU 30, and a meter ECU 40. Some or all of the ECUs 10, 20, 30, and 40 may be integrated into one ECU. Hereinafter, the collision avoidance ECU 10 will be referred to as “PCS ECU 10”.

The ECU is an electronic control unit which includes a micro-computer as a main component. The ECUs 10, 20, 30, and 40 are electrically connected to each other via a CAN (Controller Area Network) not shown to as to send and receive information to and from each other.

In this description, the micro-computer includes a CPU, a RAM, a ROM, a non-volatile memory, and an interface (I/F). For example, the PCS ECU 10 includes a micro-computer which includes a CPU 10a, a ROM 10b, a RAM 10c, a non-volatile memory 10d, and an interface (I/F) 10e. The CPU 10a is configured or programmed to realize various functions described later by executing instructions or programs or routines memorized in the ROM 10b.

The PCS ECU 10 is electrically connected to sensors described below and is configured to receive detection signals or output signals sent from the sensors.

A steering angle sensor 11 detects a steering angle of a steering wheel SW of the own vehicle VA and outputs signals which represent steering angles θ [deg], respectively. The steering angle θ takes a positive value when the steering wheel SW is rotated from a predetermined position (or a reference position or a neutral position) in a first direction or a leftward direction. On the other hand, the steering angle θ takes a negative value when the steering wheel SW is rotated from the reference position in a second direction or a rightward direction. It should be noted that the neutral position is a reference position at which the steering angle θ is zero and a position of the steering wheel SW to move the own vehicle straight.

A vehicle moving speed sensor 12 detects a moving speed of the own vehicle VA and is configured to output signals which represent moving speeds of the own vehicle VA, respectively. Hereinafter, the moving speed of the own vehicle VA will be also referred to as “vehicle moving speed Vs”.

A direction indicator switch 13 such as a blinker switch or a winker switch is a switch operated to switch states of right direction indicators 61r such as right blinkers or right winkers and states of left direction indicators 61l such as left blinkers or right winkers between an ON state and an OFF state. The driver operates a direction indicator lever (not shown) such as a blinker lever or a winker lever to activate or blink the right and left direction indicators 61r and 61l. The direction indicator lever is configured to be operated at a first position and a second position. The first position is a position at which the direction indicator lever is rotated clockwise from an initial position by a predetermined angle. The second position is a position at which the direction indicator lever is rotated counterclockwise from the initial position by the predetermined angle.

When the direction indicator lever is at the first position, the direction indicator switch 13 sets the states of the right direction indicators 61r at the ON state. In other words, the direction indicator switch 13 blinks the right direction indicators 61r. In this case, the direction indicator switch 13 outputs a signal which represents that the right direction indicators 61r are in the ON state, to the PCS ECU 10. When the direction indicator lever is at the second position, the direction indicator switch 13 sets the states of the left direction indicators 61l at the ON state. In other words, the direction indicator switch 13 blinks the left direction indicators 61l. In this case, the direction indicator switch 13 outputs a signal which represents that the left direction indicators 61l are in the ON state, to the PCS ECU 10. It should be noted that when the right and left direction indicators 61r and 61l are in the OFF state, the direction indicator switch 13 outputs a signal which represents that the right and left direction indicators 61r and 61l are in the OFF state, to the PCS ECU 10.

Surrounding sensors 14 include a camera sensor 15 and radar sensors 16a, 16b, and 16c. The surrounding sensors 14 are configured to acquire information on standing objects in a surrounding area around the own vehicle. In this embodiment, as described later, the surrounding area includes a forward area in front of the own vehicle, a right side area at the right side of the own vehicle, and a left side area at the left side of the own vehicle. The standing objects are, for example, moving objects such as four-wheeled vehicles, two-wheeled vehicles, and pedestrians, and non-moving objects such as electric poles, trees, and guard rails. Hereinafter, such standing objects will be simply referred to as “objects”. The surrounding sensors 14 are configured to calculate information on the object (hereinafter, this information will be referred to as “object information”) and output the calculated object information.

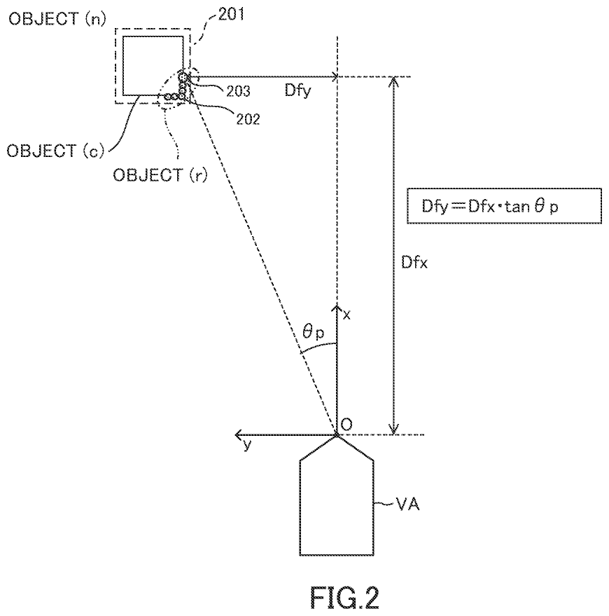

As shown in FIG. 2, the surrounding sensors 14 acquire the object information on a two dimensional map. The two dimensional map is defined by an x-axis and a y-axis. An origin of the x-axis and the y-axis is a center O of the front portion of the own vehicle VA in a width direction of the own vehicle VA. The x-axis extends in a longitudinal direction of the own vehicle VA through the center O of the own vehicle VA. Values on the x-axis which correspond to positions forward from the own vehicle VA, take positive values. The y-axis extends perpendicular to the x-axis. Values on the y-axis which correspond to positions leftward from the own vehicle VA, take positive values. The position represented with the x-axis on an x-y coordinate is referred to as “longitudinal distance Dfx”, and the position represented with the y-axis on the x-y coordinate is referred to as “lateral position Dfy”.

The object information includes information on the longitudinal distance Dfx(n) of the object (n), the lateral position Dfy(n) of the object (n), a moving direction of the object (n), and a relative speed Vfx(n) of the object (n).

The longitudinal distance Dfx(n) is a distance between the object (n) and the origin O and takes a positive or negative value in the x-axis direction. The lateral position Dfy(n) is a distance between the object (n) and the origin O and takes a positive or negative value in the y-axis direction. The relative moving speed Vfx(n) is a difference (=Vn−Vs) between a moving speed Vn of the object (n) and the moving speed Vs of the own vehicle VA. The moving speed Vn of the object (n) is a speed of the object (n) in the x-axis direction.

It should be noted that as shown in FIG. 2, the lateral position Dfy(n) is acquired, based on an orientation Op of the (n) with respect to the own vehicle VA and thus, the object information may include information on the orientation Op instead of the lateral position Dfy(n).

The camera sensor 15 includes a camera 15a and an image processing section (not shown). The camera 15a is a monocular camera or a stereo camera. It should be noted that the camera sensor 15 will be also referred to as “first sensor”.

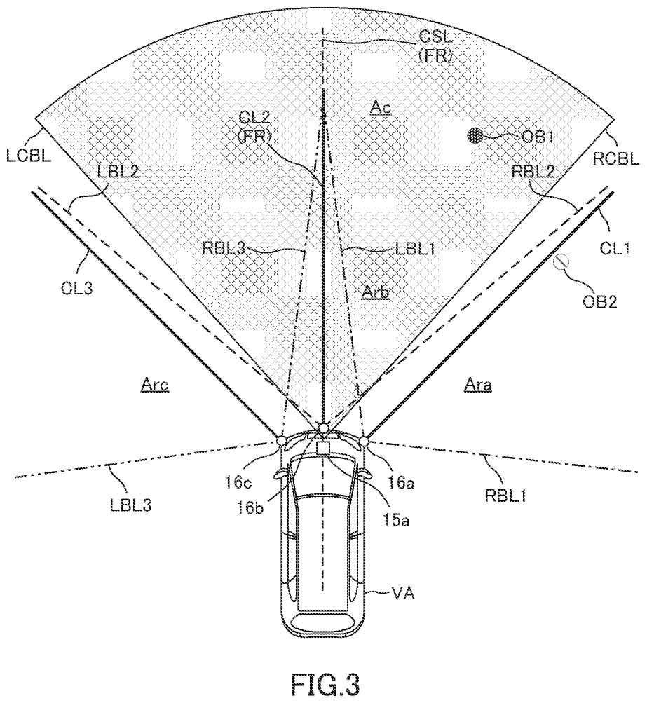

As shown in FIG. 3, the camera 15a is secured at a center of a front end portion of the own vehicle VA. The camera 15a takes images of a predetermined area around the own vehicle VA or the forward area of the own vehicle VA and acquires image data. An area Ac which the camera sensor 15 can detect the objects, has a sector-of-circle shape defined by (i) an area rightward from a detection axis CSL to a right boundary line RCBL and (ii) an area leftward from the detection axis CSL to a left boundary line LCBL. The detection axis CSL is an axis which extends forward from a center of the front end portion of the own vehicle VA in the width direction of the own vehicle VA. The area Ac will be also referred to as “first area”. The detection axis CSL corresponds to a vehicle longitudinal axis FR of the own vehicle VA.

The camera 15a takes images of the area Ac with a predetermined frame rate and outputs the image data on the taken images to the image processing section. The image processing section detects the objects in the area Ac, based on the image data. Hereinafter, the object detected by the camera sensor 15 will be referred to as “object (c)”. In addition, the image processing section acquires or calculates the object information on the objects (c), based on the image data. The PCS ECU 10 acquires the object information on the objects (c) from the camera sensor 15 as first detection information.

As shown in FIG. 3, the radar sensor 16a is secured at a right end of the front end portion of the own vehicle VA. The radar sensor 16b is secured at the center of the front end portion of the own vehicle VA. The radar sensor 16c is secured at a left end of the front end portion of the own vehicle VA. It should be noted that the radar sensors 16a, 16b, and 16c will be referred to as “radar sensors 16” if the radar sensors 16a, 16b, and 16c do not have to be distinguished from each other. Further, the radar sensors 16 will be also referred to as “second sensors”.

Each radar sensor 16 includes a radar wave transmitting/receiving section and an information processing section. The radar wave transmitting/receiving section transmits electromagnetic waves and receives the electromagnetic waves reflected on the objects within a transmitting area. The electromagnetic waves are, for example, radio waves which have a millimeter wave band. The electromagnetic waves will be also referred to as “millimeter waves”. Also, the electromagnetic waves reflected on the objects will be also referred to as “reflected waves”. It should be noted that the radar sensors 16 may be radar sensors which use radio waves of a frequency band other than the millimeter wave band.

The information processing section detects the objects, based on reflected wave information on a phase difference between the transmitted millimeter wave and the received reflected wave, an attenuation level of the reflected wave, and time taken to receive the reflected wave since transmitting the millimeter wave. As shown in FIG. 2, the information processing section groups the reflection points which are adjacent to each other or the reflection points which are adjacent to the each other and move in the same direction. Then, the information processing section detects a group of the reflection points as one object. Hereinafter, the group of the reflection points will be referred to as “reflection point group 202”. Further, hereinafter, the object detected by the radar sensors 16 will be referred to as “object (r)”.

In addition, the information processing section acquires or calculates the object information on the objects (r), based on the reflected wave information. As shown in FIG. 2, the information processing section calculates the object information with an optional point among the reflection points of the reflection point group 202. Hereinafter, the optional point among the reflection points of the reflection point group 202 will be referred to as “representative reflection point 203”. The object information includes information on the longitudinal distance Dfx of the object (r), an orientation Op of the object (r) with respect to the own vehicle VA, and the relative speed Vfx of the object (r). The information processing section sends the object information on the objects (r) to the PCS ECU 10 as second detection information.

It should be noted that the representative reflection point 203 is the reflection point which has the greatest reflection intensity in the reflection point group 202. However, the representative reflection point 203 is not limited one described above. The representative reflection point 203 may be a left end point in the reflection point group 202, or a right end point in the reflection point group 202, or an in-between reflection point between the left end point and the right end point in the reflection point group 202.

As shown in FIG. 3, an area Ara which the radar sensor 16a can detect the objects, has a sector-of-circle shape defined by (i) an area rightward from a detection axis CL1 to a right boundary line RBL1 and (ii) an area leftward from the detection axis CL1 to a left boundary line LBL1. The detection axis CL1 is an axis which extends forward right from a right end of the front end portion of the own vehicle VA. A radius of the sector-of-circle shape of the area Ara is a predetermined distance. The radar sensor 16a detects the objects in the area Ara (in this embodiment, a right forward area with respect to the own vehicle VA) as the objects (r). Then, the radar sensor 16a acquires or calculates the object information on the detected objects (r).

An area Arb which the radar sensor 16b can detect the objects, also has a sector-of-circle shape defined by (i) an area rightward from a detection axis CL2 to a right boundary line RBL2 and (ii) an area leftward from the detection axis CL2 to a left boundary line LBL2. The detection axis CL2 is an axis which extends forward from the center of the front end portion of the own vehicle VA in the width direction of the own vehicle VA. A radius of the sector-of-circle shape of the area Arb is the predetermined distance. The detection axis CL2 corresponds to the vehicle longitudinal axis FR of the own vehicle VA. The radar sensor 16b detects the objects in the area Arb (in this embodiment, the forward area in front of the own vehicle VA) as the objects (r). Then, the radar sensor 16b acquires or calculates the object information on the detected objects (r).

Similarly, an area Arc which the radar sensor 16c can detect the objects, also has a sector-of-circle shape defined by (i) an area rightward from a detection axis CL3 to a right boundary line RBL3 and (ii) an area leftward from the detection axis CL3 to a left boundary line LBL3. The detection axis CL3 is an axis which extends forward left from a left end of the front end portion of the own vehicle VA. A radius of the sector-of-circle shape of the area Arc is the predetermined distance. The radar sensor 16c detects the objects in the area Arc (in this embodiment, a left forward area with respect to the own vehicle VA) as the objects (r). Then, the radar sensor 16c acquires or calculates the object information on the detected objects (r).

An area defined by the areas Ara, Arb, and Arc will be also referred to as “second area”. As can be understood from FIG. 3, the second area includes the first area and is wider than the first area. The PCS ECU 10 acquires the object information on the objects (r) in the second area as second detection information.

As described below, the PCS ECU 10 determines whether there is a combination of the object (c) and the object (r) which can be considered to be the same object, based on the first and second detection information. Hereinafter, the object specified by the combination of the object (c) and the object (r) which can be considered to be the same object, will be referred to as “object (f)” or “fusion object”. The object in an overlapping area of the first and second areas, i.e., in the first area, is detected as the object (f).

In particular, as shown in FIG. 2, the PCS ECU 10 determines an object area 201, based on the first detection information. The object area 201 is an area on the x-y coordinate and which surrounds the object (c). The PCS ECU 10 determines whether at least a part of the reflection point group 202 which corresponds to the object (r), is included in the object area 201. When the at least a part of the reflection point group 202 which corresponds to the object (r), is included in the object area 201, the PCS ECU 10 recognizes the object (c) and the object (r) as the same object, i.e., as the object (f).

When the PCS ECU 10 recognizes the object (f), the PCS ECU 10 determines the object information on the object (f) by integrating or fusing the first and second detection information. In particular, the PCS ECU 10 acquires the longitudinal distance Dfx represented by the second detection information as the conclusive longitudinal distance Dfx of the object (f). In addition, the PCS ECU 10 determines the conclusive lateral position Dfy by calculating, based on the longitudinal distance Dfx represented by the second detection information and the orientation Op represented by the first detection information. In particular, the PCS ECU 10 determines the conclusive lateral position Dfy by Dfy=“longitudinal distance Dfx of the object (r)”*“tan θp of the object (c)”. In addition, the PCS ECU 10 acquires the relative speed Vfx represented by the second detection information as the conclusive relative speed Vfx of the object (f).

Again, referring to FIG. 1, the engine ECU 20 is electrically connected to an accelerator pedal operation amount sensor 21 and engine sensors 22. The accelerator pedal operation amount sensor 21 detects an operation amount of an accelerator pedal 51, i.e., an acceleration opening degree [%] of the accelerator pedal 51 and outputs signals which represent the operation amount of the accelerator pedal 51 to the engine ECU 20. The operation amount of the accelerator pedal 51 will be referred to as “accelerator pedal amount AP”. The accelerator pedal 51 is an acceleration operator which the driver operates to accelerate the own vehicle VA. When the driver does not operate the accelerator pedal 51, i.e., the driver does not press the accelerator pedal 51, the accelerator pedal operation amount AP is zero. As an amount by which the driver presses the accelerator pedal 51, increases, the accelerator pedal operation amount AP increases. It should be noted that the engine ECU 20 sends the detection signals received from the accelerator pedal operation amount sensor 21, to the control ECU 10.

The engine sensors 22 are sensors which detect driving state amounts of an internal combustion engine 24. The engine sensors 22 include a throttle valve opening degree sensor, an engine speed sensor, and an intake air amount sensor.

The engine ECU 20 is electrically connected to engine actuators 23. The engine actuators 23 include a throttle valve actuator which changes an opening degree of a throttle valve of the spark-ignition gasoline-injection type of the internal combustion engine 24. The engine ECU 20 can change torque generated by the internal combustion engine 24 by activating the engine actuators 23, depending on the signals from the accelerator pedal operation amount sensor 21 and the engine sensors 22. The torque generated by the internal combustion engine 24 is transmitted to driven wheels of the own vehicle VA via a transmission (not shown). Thus, the engine ECU 20 can control driving force applied to the own vehicle to change an accelerated state or an acceleration of the own vehicle by controlling the engine actuators 23.

It should be noted that when the own vehicle is a hybrid electric vehicle (HEV), the engine ECU 20 can control the driving force generated by one or both of the internal combustion engine and at least one electric motor as vehicle driving sources and applied to the own vehicle. Also, when the own vehicle is a battery electric vehicle (BEV), the engine ECU 20 can control the driving force generated by at least one electric motor as the vehicle driving source and applied to the own vehicle.

The brake ECU 30 is electrically connected to a brake pedal operation amount sensor 31 and a brake switch 32. The brake pedal operation amount sensor 31 detects an operation amount of a brake pedal 52 and outputs signals which represent the operation amount of the brake pedal 52. The operation amount of the brake pedal 52 will be referred to as “brake pedal operation amount BP”. The brake pedal 52 is a deceleration operator which the driver operates to decelerate the own vehicle VA. When the driver does not operate the brake pedal 52, i.e., the driver does not press the brake pedal 52, the brake pedal operation amount BP is zero. As an amount by which the driver presses the brake pedal 52, increases, the brake pedal operation amount BP increases. It should be noted that the brake ECU 30 sends the detection signals received from the brake pedal operation amount sensor 31, to the PCS ECU 10.

The brake switch 32 outputs ON signals to the brake ECU 30 when the brake pedal 52 is operated. On the other hand, when the brake switch 32 outputs OFF signals to the brake ECU 30 when the brake pedal 52 is not operated. It should be noted that the brake ECU 30 sends the signals received from the brake switch 32, to the PCS ECU 10.

In addition, the brake ECU 30 is electrically connected to brake actuators 33. Braking force or braking torque applied to wheels of the own vehicle VA are controlled by the brake actuators 33. The brake ECU 30 controls the brake actuators 33, depending on the signals from the brake pedal operation amount sensor 31. The brake actuators 33 adjust hydraulic pressure applied to wheel cylinders installed in brake calipers 34b to press brake pads to brake discs 34a by the hydraulic pressure to generate friction braking force. Thus, the brake ECU 30 can control the braking force applied to the own vehicle to change the accelerated state, i.e., a deceleration or a negative acceleration of the own vehicle by controlling the brake actuators 33.

In addition, the meter ECU 40 is electrically connected to a speaker 41 and a display 42. The display 42 is a multi-information display provided in front of a driver's seat. The display 42 displays measured values such as the vehicle moving speed Vs and an engine speed, and various information. It should be noted that the display 42 may be a head-up display.

The meter ECU 40 outputs alerting sounds for alerting the driver from the speaker 41 in response to commands sent from the PCS ECU 10 while the PCS ECU 10 executes the PCS control. In addition, the meter ECU 40 displays alerting marks such as a warning lamp on the display 42 while the PCS ECU 10 executes the PCS control.

<Summary of PCS Control>

The PCS ECU 10 is configured to execute the known PCS control when there is an object or an obstacle with which the own vehicle VA is likely to collide. The PCS control is a control of preventing the own vehicle VA from approaching the object around the own vehicle VA or reducing damage derived from a collision of the own vehicle VA and the object.

In particular, the PCS ECU 10 recognizes the objects around the own vehicle VA, based on the object information. Then, the PCS ECU 10 selects the object with which the own vehicle VA may collide, from among the recognized objects. Hereinafter, the selected object will be referred to as “control target object”. It should be noted that the PCS ECU 10 may be configured to select the control target object, based on the moving direction of the own vehicle VA and the moving direction of the object.

The PCS ECU 10 calculates a predicted collision time TTC (Time To Collision), based on the distance (i.e., the longitudinal distance Dfx) from the own vehicle VA to the control target object and the relative speed Vfx. The predicted collision time TTC is a time which the own vehicle VA will take to collide with the control target object. The predicted collision time TTC is calculated by dividing the longitudinal distance Dfx by the relative speed Vfx. The PCS ECU 10 determines whether a predetermined condition (hereinafter, this predetermined condition will be referred to as “PCS executing condition”) is satisfied. The PCS executing condition is satisfied when the predicted collision time TTC is shorter than or equal to a predetermined threshold (in this embodiment, a time threshold Tth). When the predicted collision time TTC is shorter than or equal to the time threshold Tth, the own vehicle VA is likely to collide with the control target object. Thus, when the PCS executing condition is satisfied, the PCS ECU 10 executes the PCS control.

The PCS control includes a driving force limiting control, a braking force control, and an alerting control. The driving force limiting control is a control of limiting the driving force applied to the own vehicle VA. The braking force control is a control of applying the braking force to the wheels of the own vehicle VA. The alerting control is a control of alerting the driver of the own vehicle VA. In particular, the PCS ECU 10 sends driving command signals to the engine ECU 20. When the engine ECU 20 receives the driving command signals from the PCS ECU 10, the engine ECU 20 controls the engine actuators 23 to limit the driving force applied to the own vehicle VA so as to control the actual acceleration of the own vehicle VA to a target acceleration AG (for example, zero) represented by the driving command signal. In addition, the PCS ECU 10 sends braking command signals to the brake ECU 30. When the brake ECU 30 receives the braking command signals from the PCS ECU 10, the brake ECU 30 controls the brake actuators 33 to apply the braking force to the wheels of the own vehicle VA so as to control the actual acceleration of the own vehicle VA to a target deceleration TG represented by the braking command signal. In addition, the PCS ECU 10 sends alerting command signals to the meter ECU 40. When the meter ECU 40 receives the alerting command signals from the PCS ECU 10, the meter ECU 40 displays the alerting mark on the display 42 and outputs the alerting sounds from the speaker 41.

<Determination of Mistaken Operation to Accelerator Pedal>

Next, a determining process of determining the mistaken operation to the accelerator pedal 51 will be described. Hereinafter, a region of the accelerator pedal operation amount AP or the accelerator pedal opening degree takes is divided into three regions described below. For example, a region of the acceleration opening degree from zero to a degree smaller than 20 [%] will be referred to as “a low opening degree region”. Further, a region of the acceleration opening degree from 20 [%] to a degree smaller than 80 [%] will be referred to as “a middle opening degree region”. Furthermore, a region of the acceleration opening degree greater than or equal to 80 [%] will be referred to as “a high opening degree region”. Further, a change amount of the accelerator pedal operation amount AP per unit time will be referred to as “accelerator pedal operation speed APV [%/s] or acceleration opening degree speed APV [%/s]”.

As described above, when the driver is panicked, the driver may mistakenly operate the accelerator pedal 51 and considerably operate the steering wheel SW. Hereinafter, an operation carried out by the driver to mistakenly operate the accelerator pedal 51 and considerably operate the steering wheel SW will be referred to as “first mistaken operation”. The inventors of this application have got knowledge described below on the first mistaken operation after studying past data on the mistaken operation to the accelerator pedal. After the driver rapidly operates the accelerator pedal 51, i.e., the accelerator pedal operation speed APV increases, the accelerator pedal operation amount AP tends to reach a great value. In addition, a magnitude of the steering angle θ is great.

Accordingly, the PCS ECU 10 determines that the first mistaken operation is carried out when conditions A1 to A3 described below all become satisfied.

Condition A1: The accelerator pedal operation speed APV is greater than or equal to a threshold (in this embodiment, a first operation speed threshold APVth1).

Condition A2: The accelerator pedal operation amount AP is greater than or equal to a threshold (in this embodiment, a first operation amount threshold APth1). Determining whether the condition A2 is satisfied, is performed after the condition A1 becomes satisfied. The first operation amount threshold APth1 is set to a value greater than or equal to a relatively high value, for example, the accelerator pedal opening degree of 70 [%] in the middle opening degree region. It should be noted that the first operation amount threshold APth1 is set to a value smaller than a second operation amount threshold APth2 described later.

Condition A3: The magnitude or an absolute value of the steering angle θ is greater than a threshold (in this embodiment, a first steering angle threshold θth1). The first steering angle threshold θth1 is a threshold used to determine whether the driver considerably operates the steering wheel SW. Thus, the first steering angle threshold θth1 is set to a relatively great value. It should be noted that the first steering angle threshold θth1 is set to a value greater than a second steering angle threshold θth2 described later.

The conditions A1 and A2 are conditions used to determine whether the driver mistakenly and strongly presses the accelerator pedal 51. Hereinafter, the conditions A1 and A2 will be also collectively referred to as “first pressing condition”.

On the other hand, the driver may mistakenly operate the accelerator pedal 51 almost without operating the steering wheel SW. Hereinafter, an operation carried out by the driver to mistakenly operate the accelerator pedal 51 almost without operating the steering wheel SW will be referred to as “second mistaken operation”. The inventors of this application have got knowledge described below on the second mistaken operation after studying the past data on the mistaken operation to the accelerator pedal. After the driver rapidly operates the accelerator pedal 51, i.e., the accelerator pedal operation speed APV increases, the accelerator pedal operation amount AP tends to reach a value in the high opening degree region.

Accordingly, the PCS ECU 10 determines that the second mistaken operation is carried out when conditions B1 to B3 described below all become satisfied.

Condition B1: The accelerator pedal operation speed APV is greater than or equal to a threshold (in this embodiment, a second operation speed threshold APVth2). In this embodiment, the second operation speed threshold APVth2 is set to the same value as the first operation speed threshold APVth1. However, the second operation speed threshold APVth2 may be greater than the first operation speed threshold APVth1.

Condition B2: The accelerator pedal operation amount AP is greater than or equal to a threshold (in this embodiment, a second operation amount threshold APth2). Determining whether the condition B2 is satisfied, is performed after the condition B1 becomes satisfied. The second operation amount threshold APth2 is set to a value greater than the first operation amount threshold APth1 (APth2>APth1). The second operation amount threshold APth2 is set to a value greater than or equal to a lower limit value of the high opening degree region, for example, the accelerator pedal opening degree of 80 [%].

Condition B3: The magnitude or the absolute value of the steering angle θ is smaller than a threshold (in this embodiment, a second steering angle threshold θth2). The second steering angle threshold θth2 is a threshold used to determine whether the driver operates the steering wheel SW. Thus, when the condition B3 is satisfied, the driver is considered not to operate the steering wheel SW. The second steering angle threshold θth2 is set to a value smaller than the first steering angle threshold θth1 (θth2<θth1).

The conditions B1 and B2 are conditions used to determine whether the driver mistakenly and strongly presses the accelerator pedal 51. Hereinafter, the conditions B1 and B2 will be also collectively referred to as “second pressing condition”.

<Permission of Execution of PCS Control>

When the driver carries out a driving operation which is determined as the first or second mistaken operation, but there is no object near the own vehicle VA, the driver may intentionally and strongly operate the accelerator pedal 51. In this case, the PCS ECU 10 forbids itself to execute the PCS control.

On the other hand, when there is the object near the own vehicle VA, the own vehicle VA should be prevented from approaching the object. In this case, the PCS ECU 10 permits itself to execute the PCS control. Below, a process of permitting the PCS ECU 10 to execute the PCS control will be described as to the first and second mistaken operations.

<First Mistaken Operation>

When the driver carries out the first mistaken operation, the own vehicle VA is considerably turning. In an example shown in FIG. 3, if the own vehicle VA is turning right, the own vehicle VA may approach a first object OB1. The first object OB1 is in a first area. Thus, the first object OB1 is detected by the camera sensor 15 and at least one of the radar sensors 16. Thus, the PCS ECU 10 recognizes the first object OB1 as the object (f).

Also, the own vehicle VA may approach a second object OB2. The second object OB2 is outside of the first area, but in the second area. Thus, the second object OB2 is detected only by the radar sensor 16 (in particular, the radar sensor 16a). Thus, the PCS ECU 10 recognizes the second object OB2 as the object (r).

When the own vehicle VA is turning, the PCS ECU 10 selects the control target object which the PCS control targets, from among the objects detected from a wider area (the second area). In particular, the PCS ECU 10 selects the control target object from among the objects (f) and the objects (r). For example, the PCS ECU 10 selects the object nearest the own vehicle VA from among the objects (f) and the objects (r) as the control target object.

Further, a behavior of the own vehicle VA (in particular, the moving direction of the own vehicle VA) considerably changes. Thus, the PCS ECU 10 permits itself to execute the PCS control at early timing. In particular, the PCS ECU 10 calculates a distance Dto between the own vehicle VA and the control target object. When the distance Dto is shorter than a threshold (in this embodiment, a first distance threshold Dth1), the PCS ECU 10 permits itself to execute the PCS control. The first distance threshold Dth1 is set to a value greater than a second distance threshold Dth2 described later (Dth1>Dth2). After the PCS ECU 10 permits itself to execute the PCS control, the PCS ECU 10 determines whether the PCS executing condition is satisfied. When the PCS executing condition becomes satisfied, the PCS ECU 10 executes the PCS control.

On the other hand, when the distance Dto is longer than or equal to the first distance threshold Dth1, the PCS ECU 10 forbids itself to execute the PCS control.

Hereinafter, a situation that (i) the driver carries out the first mistaken operation, and (ii) the distance Dto is shorter than the first distance threshold Dth1, will be also referred to as “first situation”.

<Second Mistaken Operation>

When the driver carries out the second mistaken operation, the own vehicle VA is considerably turning. Thus, the PCS ECU 10 selects the control target object from among the objects (f) detected from the first area (for example, the first object OB1). In particular, the PCS ECU 10 selects the object nearest the own vehicle VA from among the objects (f) as the control target object.

In addition, the PCS ECU 10 calculates the distance Dto. When the distance Dto is shorter than the second distance threshold Dth2, the PCS ECU 10 permits itself to execute the PCS control. The second distance threshold Dth2 is set to a value smaller than the first distance threshold Dth1. When the second mistaken operation is carried out, the driver may intentionally and strongly operate the accelerator pedal 51. For example, the driver may strongly press the accelerator pedal 51 to rapidly start the own vehicle VA after the driver stops the own vehicle VA before a traffic signal. Thus, when the second mistaken operation is carried out, the PCS ECU 10 permits itself to execute the PCS control at a later timing, compared with when the first mistaken operation is carried out. Thus, the PCS control can be prevented from being executed in an unnecessary situation. After the PCS ECU 10 permits itself to execute the PCS control, the PCS ECU 10 determines whether the PCS executing condition is satisfied. When the PCS executing condition becomes satisfied, the PCS ECU 10 executes the PCS control.

On the other hand, when the distance Dto is longer than or equal to the second distance threshold Dth2, the PCS ECU 10 forbids itself to execute the PCS control.

Hereinafter, a situation that (i) the driver carries out the second mistaken operation, and (ii) the distance Dto is shorter than the second distance threshold Dth2, will be also referred to as “second situation”.

<Override Control>

The PCS ECU 10 is configured to execute the known override control. The override control is a control in response to the driving operations carried out by the driver, i.e., intension of the driver. In this embodiment, the override control is a control in response to the driving operations carried out by the driver without executing the PCS control. In particular, the PCS ECU 10 permits the engine ECU 20 to output a requested value (i.e., a requested value of output torque output from the internal combustion engine 24), depending on the accelerator pedal operation amount AP, to the engine actuators 23.

However, when the first or second situation arises, the own vehicle VA is likely to approach the object. Thus, the PCS ECU 10 prioritizes the execution of the PCS control over the execution of the control in response to the driving operations carried out by the driver. In particular, the PCS ECU 10 forbids itself to execute the override control. In this case, the PCS ECU 10 forbids the engine ECU 20 to accelerate the own vehicle VA, based on the accelerator pedal operation amount AP. In particular, the PCS ECU 10 forbids the engine ECU 20 to output the requested value, depending on the accelerator pedal operation amount AP, to the engine actuators 23. In addition, when the PCS ECU 10 forbids the engine ECU 20 to execute the override control, the PCS ECU 10 causes the engine ECU 20 to execute processes described below. In this case, the engine ECU 20 limits the requested value output to the engine actuators 23 to a predetermined upper limit value in response to commands sent from the PCS ECU 10. Thus, the PCS ECU 10 limits the driving force.

<Stop of PCS Control>

Hereinafter, a change amount of the steering angle θ per unit time will be referred to as “steering operation speed OV [deg/s]”.

After the PCS control is started to be executed, the driver may carry out the driving operation (in particular, an operation of operating the steering wheel) for avoiding the collision of the own vehicle with the object. Thus, in this embodiment, the PCS ECU 10 determines whether a stopping condition described below is satisfied after the PCS ECU 10 starts to execute the PCS control. The stopping condition is a condition used to determine whether the PCS ECU 10 should stop or terminate executing the PCS control. When a condition C1 described below becomes satisfied, the PCS ECU 10 determines that the stopping condition becomes satisfied.

Condition C1: The steering operation speed θV continues to be greater than a threshold (in this embodiment, a first steering operation speed threshold θVth1) for a predetermined time Tsv or more.

When the driver carries out the first mistaken operation, the driver has considerably operated the steering wheel SW. Thus, the steering operation speed θV is unlikely to increase. Thus, the condition C1 does not become satisfied. Thus, the PCS ECU 10 continues executing the PCS control. With this configuration, when the driver carries out the first mistaken operation, the execution of the PCS control is unlikely to be stopped. Thus, the own vehicle VA can be prevented from approaching the object.

On the other hand, when the driver carries out the second mistaken operation, the driver does not substantially operate the steering wheel SW. Then, when the driver considerably operates the steering wheel SW, the driver probably carries out the steering operation for avoiding the collision of the own vehicle VA with the object. In this case, the condition C1 becomes satisfied. Thus, the PCS ECU 10 stops executing the PCS control. With this configuration, when the driver considerably operates the steering wheel SW after carrying out the second mistaken operation, the driving operations carried out by the driver can be used to control the own vehicle VA. Thus, the own vehicle VA can be prevented from approaching the object by the driving operations carried out by the driver.

<Operations>

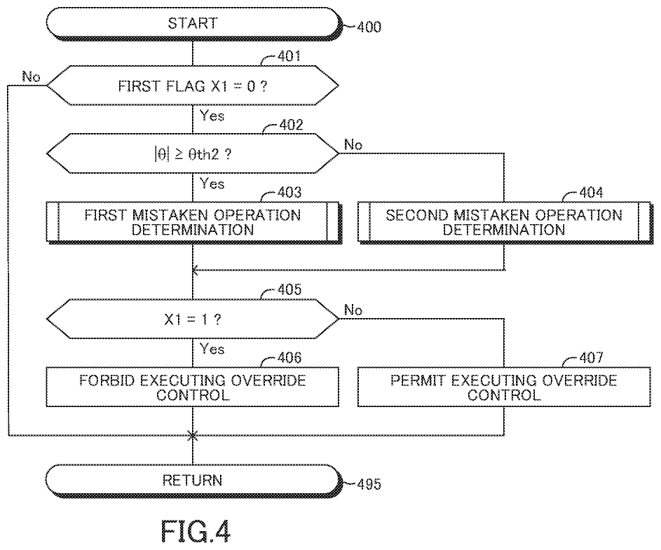

The CPU 10a of the PCS ECU 10 (hereinafter, the CPU 10a will be simply referred to as “CPU”) is configured or programed to execute a first flag setting routine shown in FIG. 4 each time a predetermined time (for example, a first time) elapses.

It should be noted that the CPU receives the detection signals or the output signals from the sensors (11, 12, 14, 21, 22, and 31) and the switches (13 and 32) and stores the received detection signals or the received output signals in the RAM 10c each time the first time elapses.

At a predetermined timing, the CPU starts a process from a step 400 of the routine shown in FIG. 4 and proceeds with the process to a step 401 to determine whether a value of a first flag X1 is “0”. The first flag X1 represents that the execution of the PCS control is forbidden when the value of the first flag X1 is “0”. On the other hand, when the value of the first flag X1 is “1”, the first flag X1 represents that the execution of the PCS control is permitted. It should be noted that the value of the first flag X1 is set to “0” by an initializing routine executed by the CPU when a state of an ignition switch not shown is changed from OFF to ON.

When the value of the first flag X1 is not “0”, the CPU determines “No” at the step 401 and proceeds with the process directly to a step 495 to terminate executing this routine once.

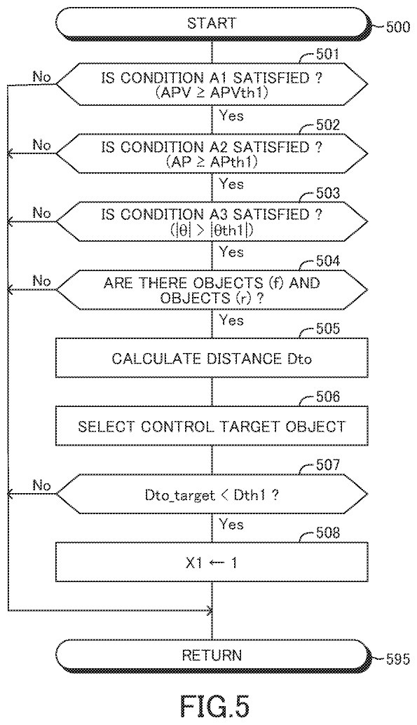

On the other hand, when the value of the first flag X1 is “0”, the CPU determines “Yes” at the step 401 and proceeds with the process to a step 402 to determine whether the magnitude or the absolute value of the steering angle θ is greater than or equal to the second steering angle threshold θth2. In other words, the CPU determines whether the driver substantially operates the steering wheel SW. When the magnitude of the steering angle θ is greater than or equal to the second steering angle threshold θth2, the CPU determines “Yes” at the step 402 and proceeds with the process to a step 403 to execute a first mistaken operation determining routine shown in FIG. 5. Details of the first mistaken operation determining routine will be described later. Then, the CPU proceeds with the process to a step 405.

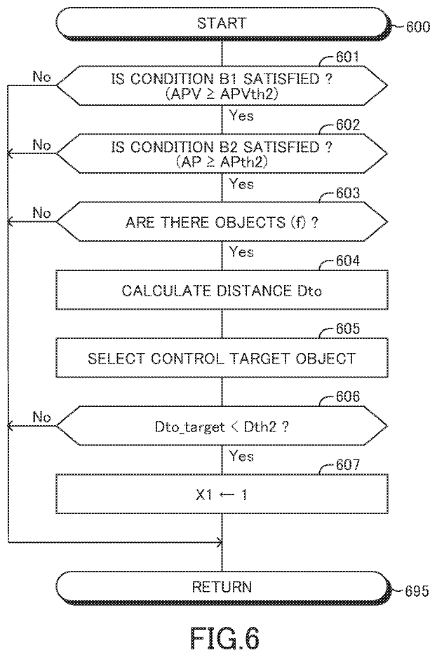

On the other hand, when the magnitude of the steering angle θ is smaller than the second steering angle threshold θth2, the CPU determines “No” at the step 402 and proceeds with the process to a step 404 to execute a second mistaken operation determining routine shown in FIG. 6. Details of the second mistaken operation determining routine will be described later. Then, the CPU proceeds with the process to the step 405.

When the CPU proceeds with the process to the step 405, the CPU determines whether the value of the first flag X1 is “1”. The value of the first flag X1 may be set to “1” by the first or second mistaken operation determining routines. When the value of the first flag X1 is “1”, the CPU determines “Yes” at the step 405 and proceeds with the process to a step 406 to forbid the engine ECU 20 to execute the override control. In particular, the CPU forbids the engine ECU 20 to accelerate the own vehicle VA, based on the accelerator pedal operation amount AP. In addition, the engine ECU 20 limits the requested value output to the engine actuators 23 to the predetermined upper limit value in response to the commands sent from the CPU to limit the driving force. Then, the CPU proceeds with the process to the step 495 to terminate executing this routine once.

On the other hand, when the value of the first flag X1 is “0”, the CPU determines “No” at the step 405 and proceeds with the process to a step 407 to permit the engine ECU 20 to execute the override control. In particular, the CPU permits the engine ECU 20 to output the requested value, depending on the accelerator pedal operation amount AP, to the engine actuators 23. Then, the CPU proceeds with the process to the step 495 to terminate executing this routine once.

Next, the routine which the CPU executes at the step 403 of the routine shown in FIG. 4 will be described. When the CPU proceeds with the process to the step 403, the CPU starts a process from a step 500 of the routine shown in FIG. 5 and proceeds with the process to a step 501. At the step 501, the CPU determines whether the condition A1 is satisfied. In particular, the CPU determines whether the accelerator pedal operation speed APV is greater than or equal to the first operation speed threshold ΔPVth1. When the condition A1 is not satisfied, the CPU determines “No” at the step 501 and proceeds with the process directly to a step 595.

On the other hand, when the condition A1 is satisfied, the CPU determines “Yes” at the step 501 and proceeds with the process to a step 502 to determine whether the condition A2 is satisfied. In particular, the CPU determines whether the accelerator pedal operation amount AP is greater than or equal to the first operation amount threshold APth1. When the condition A2 is not satisfied, the CPU determines “No” at the step 502 and proceeds with the process directly to the step 595.

On the other hand, when the condition A2 is satisfied, the CPU determines “Yes” at the step 502 and proceeds with the process to a step 503 to determine whether the condition A3 is satisfied. In particular, the CPU determines whether the magnitude of the steering angle θ is greater than the first steering angle threshold θth1. When the condition A3 is not satisfied, the CPU determines “No” at the step 503 and proceeds with the process directly to the step 595.

On the other hand, when the condition A3 is satisfied, the CPU determines “Yes” at the step 503 and proceeds with the process to a step 504 to determine whether there are the objects (f) and/or the objects (r) in the surrounding area around the own vehicle VA, based on the object information. When there are nether the object (f) nor the object (r), the CPU determines “No” at the step 504 and proceeds with the process directly to the step 595.

On the other hand, when there is at least one object (the objects (f) and/or the objects (r)), the CPU determines “Yes” at the step 504 and sequentially executes processes of steps 505 and 506 described below. Then, the CPU proceeds with the process to a step 507.

Step 505: The CPU calculates the distance Dto of each of the objects recognized at the step 504 as described above.

Step 506: The CPU selects the control target object. When there is one object in the surrounding area, the CPU selects the one object as the control target object. When there is two or more objects in the surrounding area, the CPU selects the object which has the shortest distance Dto from among the recognized objects. Hereinafter, the distance Dto of the control target object will be referred to as “distance Dto_target”.

Next, at the step 507, the CPU determines whether the distance Dto_target is shorter than the first distance threshold Dth1. When the distance Dto_target is shorter than the first distance threshold Dth1, the CPU determines “Yes” at the step 507 and proceeds with the process to a step 508. The present situation corresponds to the first situation. Thus, at the step 508, the CPU permits itself to execute the PCS control. In particular, at the step 508, the CPU sets the value of the first flag X1 to “1”. Then, the CPU proceeds with the process to the step 595.

On the other hand, when the distance Dto_target is longer than or equal to the first distance threshold Dth1, the CPU determines “No” at the step 507 and proceeds with the process directly to the step 595.

It should be noted that when the CPU proceeds with the process to the step 595, the CPU terminates executing this routine and proceeds with the process to the step 405 of the routine shown in FIG. 4.

Next, the routine which the CPU executes at the step 404 of the routine shown in FIG. 4 will be described. When the CPU proceeds with the process to the step 404, the CPU starts a process from a step 600 of the routine shown in FIG. 6 and proceeds with the process to a step 601. At the step 601, the CPU determines whether the condition B1 is satisfied. In particular, the CPU determines whether the accelerator pedal operation speed APV is greater than or equal to the second operation speed threshold APVth2. When the condition B1 is not satisfied, the CPU determines “No” at the step 601 and proceeds with the process directly to a step 695.

On the other hand, when the condition B1 is satisfied, the CPU determines “Yes” at the step 601 and proceeds with the process to a step 602 to determine whether the condition B2 is satisfied. In particular, the CPU determines whether the accelerator pedal operation amount AP is greater than or equal to the second operation amount threshold APth2. When the condition B2 is not satisfied, the CPU determines “No” at the step 602 and proceeds with the process directly to the step 695.

On the other hand, when the condition B2 is satisfied, the CPU determines “Yes” at the step 602 and proceeds with the process to a step 603 to determine whether there are the objects (f) in the first area. When there are no objects (f), the CPU determines “No” at the step 603 and proceeds with the process directly to the step 695.

On the other hand, when there is at least one object (f), the CPU determines “Yes” at the step 603 and sequentially executes processes of steps 604 and 605 described below. Then, the CPU proceeds with the process to a step 606.

Step 604: The CPU calculates the distance Dto of each of the objects (f) detected at the step 603 as described above.

Step 605: The CPU selects the control target object. When there is one object (f), the CPU selects the one object (f) as the control target object. When there is two or more objects (f), the CPU selects the object (f) which has the shortest distance Dto from among the detected objects (f).

Next, at the step 606, the CPU determines whether the distance Dto_target is shorter than the second distance threshold Dth2. When the distance Dto_target is shorter than the second distance threshold Dth2, the CPU determines “Yes” at the step 606 and proceeds with the process to a step 607. The present situation corresponds to the second situation. Thus, at the step 607, the CPU permits itself to execute the PCS control. In particular, at the step 607, the CPU sets the value of the first flag X1 to “1”. Then, the CPU proceeds with the process to the step 695.

On the other hand, when the distance Dto_target is longer than or equal to the second distance threshold Dth2, the CPU determines “No” at the step 606 and proceeds with the process directly to the step 695.

It should be noted that when the CPU proceeds with the process to the step 695, the CPU terminates executing this routine and proceeds with the process to the step 405 of the routine shown in FIG. 4.

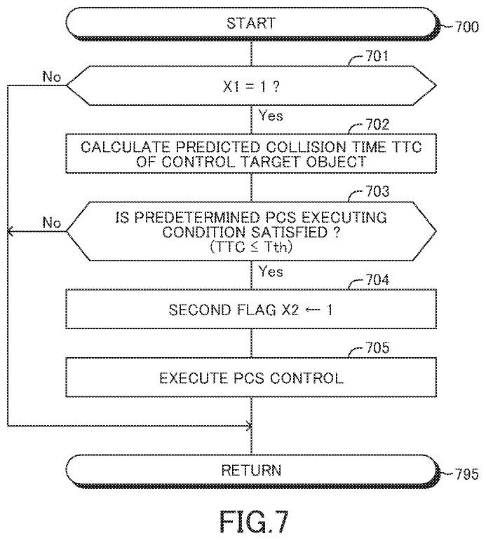

Further, the CPU is configured or programmed to execute a PCS control executing routine shown in FIG. 7 each time the first time elapses. The CPU starts a process from a step 700 of the routine shown in FIG. 7 and proceeds with the process to a step 701 to determine whether the value of the first flag X1 is “1”. When the value of the first flag X1 is “0”, the CPU determines “Yes” at the step 701 and proceeds with the process directly to a step 795 to terminate executing this routine once.

When the CPU sets the value of the first flag X1 to “1” by the routine shown in FIG. 5 or FIG. 6, and the CPU proceeds with the process to the step 701, the CPU determines “Yes” at the step 701. Then, the CPU proceeds with the process to a step 702 to calculate the predicted collision time TTC of the control target object.

Then, the CPU proceeds with the process to a step 703 to determine whether the PCS executing condition is satisfied. In particular, the CPU determines whether the predicted collision time TTC is shorter than or equal to the time threshold Tth. When the PCS executing condition is not satisfied, the CPU determines “No” at the step 703 and proceeds with the process directly to the step 795 to terminate executing this routine once.

On the other hand, when the PCS executing condition is satisfied, the CPU determines “Yes” at the step 703 and sequentially executes processes of steps 704 and 705 described below. Then, the CPU proceeds with the process to the step 795 to terminate executing this routine once.

Step 704: The CPU sets a value of a second flag X2 to “1”. The second flag X2 represents that the PCS control is not executed when the value of the second flag X2 is “0”. On the other hand, when the value of the second flag X2 is “1”, the second flag X2 represents that the PCS control is being executed. It should be noted that the value of the second flag X2 is set to “0” by the initializing routine.

Step 705: The CPU executes the PCS control.

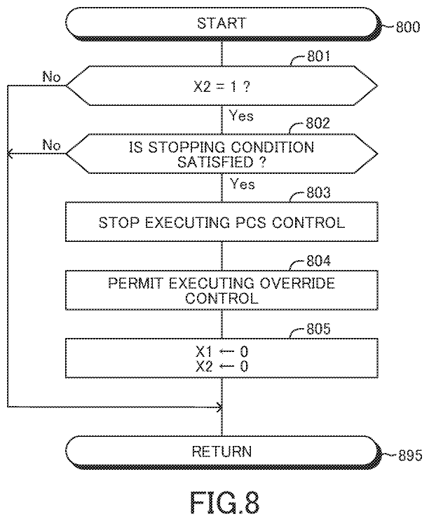

Further, the CPU is configured or programmed to execute a PCS control stopping routine shown in FIG. 8 each time the first time elapses. The CPU starts a process from a step 800 of the routine shown in FIG. 8 and proceeds with the process to a step 801 to determine whether the value of the second flag X2 is “1”. When the value of the second flag X2 is “0”, the CPU determines “No” at the step 801 and proceeds with the process directly to a step 895 to terminate executing this routine once.

When (i) the CPU sets the value of the second flag X2 to “1” by the routine shown in FIG. 7, i.e., the CPU starts to execute the PCS control, and (ii) the CPU proceeds with the process to the step 801, the CPU determines “Yes” at the step 801. Then, the CPU proceeds with the process to a step 802 to determine whether the stopping condition is satisfied. When the stopping condition is satisfied, the CPU determines “No” at the step 802 and proceeds with the process directly to the step 895 to terminate executing this routine once. Thus, the CPU continues executing the PCS control.

On the other hand, when the stopping condition is satisfied, the CPU determines “Yes” at the step 802 and sequentially executes processes of steps 803 to 805 described below. Then, the CPU proceeds with the process to the step 895 to terminate executing this routine once.

Step 803: The CPU stops executing the PCS control.

Step 804: The CPU permits the engine ECU 20 to execute the override control. In particular, the CPU permits the engine ECU 20 to output the requested value, depending on the accelerator pedal operation amount AP to the engine actuators 23.

Step 805: The CPU sets the value of the first flag X1 to “0” and sets the value of the second flag X2 to “0”.

The vehicle control apparatus according to the embodiment provides effects described below. With the above-described configuration, the vehicle control apparatus can execute the PCS control even when the driver is panicked and strongly operates the accelerator pedal 51 and considerably operates the steering wheel SW, i.e., the first mistaken operation is carried out.

The vehicle control apparatus forbids executing the override control in the first situation that (i) the driver carries out the first mistaken operation, and (ii) the distance Dto is shorter than the first distance threshold Dth1. Thereby, the vehicle control apparatus forbids accelerating the own vehicle VA, based on the accelerator pedal operation amount AP. Thereby, the own vehicle VA is not accelerated when the first mistaken operation is carried out. Thus, the own vehicle VA can be prevented from approaching the object in the surrounding area around the own vehicle VA.

Further, when the first mistaken operation is carried out, the own vehicle VA turns considerably. Accordingly, the vehicle control apparatus selects the control target object from among the objects detected from the wider area (i.e., the second area). In particular, the vehicle control apparatus selects the control target object from among the objects (f) and the objects (r). Thereby, the vehicle control apparatus can surely prevent the own vehicle VA from approaching the object in the surrounding area around the own vehicle VA.

Further, when the first mistaken operation is carried out, the driver is probably panicked. When this is the case, the vehicle control apparatus forbids executing the override control and permits executing the PCS control at an earlier timing, compared with when the second mistaken operation is carried out. Thereby, the vehicle control apparatus can surely prevent the own vehicle VA from approaching the object in the surrounding area around the own vehicle VA.

It should be noted that the invention is not limited to the aforementioned embodiments, and various modifications can be employed within the scope of the invention.

### First Modified Example

The vehicle control apparatus according to a first modified example of the embodiment of the invention is configured to permit executing the PCS control in consideration of an operated state of the brake pedal 52 and an activated state of the direction indicators (61r or 61l). Below, mainly, a configuration of the vehicle control apparatus according to the first modified example different from the vehicle control apparatus according to the embodiment, will be described.

The inventors of this application have got knowledge that the driver intentionally operates the accelerator pedal 51 in a situation described below That is, the driver stops the own vehicle VA by pressing the brake pedal 52. Then, the driver strongly presses the accelerator pedal 51 to start the own vehicle VA. In this situation, the driver has operated the brake pedal 52 just before starting to press the accelerator pedal 51. Thus, the driver distinguishes the accelerator pedal 51 and the brake pedal 52 from each other. In other words, the driver intentionally and strongly operates the accelerator pedal 51. Thus, the driver does not carry out the mistaken operation to the accelerator pedal 51.

On the other hand, when the driver has not operated the brake pedal 52 for long time, the driver may not distinguish the accelerator pedal 51 and the brake pedal 52 from each other. In particular, when a long time elapses since the driver stops operating the brake pedal 52, the mistaken operation to the accelerator pedal 51 may be carried out.

Accordingly, the PCS ECU 10 determines whether a condition D1 described below is satisfied.

Condition D1: An elapsed time Ta which elapses since the PCS ECU 10 receives the OFF signal from the brake switch 32, is longer than or equal to a predetermined time (in this embodiment, a first time threshold Tath). The elapsed time Ta corresponds to a period that the signal sent from the brake switch 32 continues to be the OFF signal since the signal sent from the brake switch 32 changes from the ON signal to the OFF signal. In other words, the elapsed time Ta corresponds to a period that the brake pedal 52 has not been operated since the driver stops operating the brake pedal 52.

Further, just after the state of the right or left direction indicators 61r or 61l changes from the ON state to the OFF state, the own vehicle VA may be overtaking the preceding vehicle. Also, in this case, the driver intentionally and strongly operates the accelerator pedal 51. Hereinafter, a point of time when the state of the right or left direction indicators 61r or 61l changes from the ON states to the OFF states will be also referred to as “direction indicator off time”.

Accordingly, the PCS ECU 10 determines whether a condition D2 described below is satisfied.

Condition D2: An elapsed time Tb which elapses since the direction indicator off time, is longer than or equal to a threshold (in the embodiment, a second time threshold Tbth). The elapsed time Tb is a time that the right or left direction indicators 61r or 61l keep the OFF state since the direction indicator off time.

<Operations>

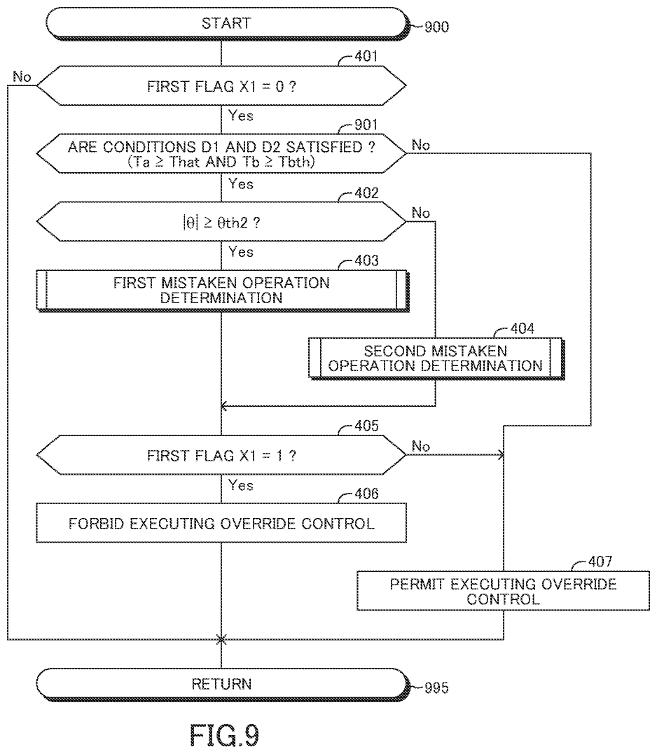

The CPU is configured or programmed to execute a routine shown in FIG. 9 instead of the routine shown in FIG. 4. The routine shown in FIG. 9 corresponds to the routine shown in FIG. 4 added by a step 901. It should be noted that in the routine shown in FIG. 9, steps of executing the same processes as those of the routine shown in FIG. 4 are indicated with the same reference symbols as those of the routine shown in FIG. 4. Below, descriptions of the steps of executing the same processes of the routine shown in FIG. 9 as those of the routine shown in FIG. 4, will be omitted.

The CPU starts a process from a step 900 of the routine shown in FIG. 9. When the CPU proceeds with the process to a step 901 after the step 401, the CPU determines whether the conditions D1 and D2 are both satisfied. When the conditions D1 and D2 are both satisfied, the CPU determines “Yes” at the step 901 and proceeds with the process to the step 402. The processes of the step 402 and the steps following it are the same processes of the above-described embodiment.

When at least one of the conditions D1 and D2 is not satisfied, the CPU determines “No” at the step 901 and proceeds with the process to the step 407 to permit the engine ECU 20 to execute the override control. In particular, the CPU permits the engine ECU 20 to output the requested value, depending on the accelerator pedal operation amount AP, to the engine actuators 23. Then, the CPU proceeds with the process to a step 995 to terminate executing this routine once.

The vehicle control apparatus with the configuration described above can forbid executing the override control and permit executing the PCS control in consideration of the operated state of the brake pedal 52 and the activated state of the direction indicators 61r or 61l.

### Second Modified Example

The acceleration operator is not limited to the accelerator pedal 51. For example, the acceleration operation may be an accelerator lever. The deceleration operator is not limited to the brake pedal 52. For example, the deceleration operator may be a brake lever.

### Third Modified Example

The accelerator pedal operation amount AP is not limited to one described above (i.e., the accelerator pedal opening degree). The accelerator pedal operation amount AP may be information on an accelerator pedal signal. The accelerator pedal signal is output as a voltage which changes or increases, depending on the operation amount of the accelerator pedal 51.

### Fourth Modified Example

The PCS executing condition is not limited to one described above. For example, the PCS executing condition may be a condition which is satisfied when the distance Dto_target is shorter than a predetermined threshold (in this embodiment, a third distance threshold Dth3). In this example, the third distance threshold Dth3 may be set to a value smaller than or equal to the second distance threshold Dth2. Thus, a relational expression below is satisfied.

Dth3≤Dth2<Dth1

### Fifth Modified Example

The stopping condition is not limited to one described above. The stopping condition may include a condition C2 described below. In this case, the PCS ECU 10 determine that the stopping condition becomes satisfied when one of the conditions C1 and C2 becomes satisfied.

Condition C2: The accelerator pedal operation speed APV is greater than or equal to a third operation speed threshold APVth3, or the accelerator pedal operation amount AP is greater than or equal to a third operation amount threshold APth3.

The surrounding sensors 14 may make mistaken detections. For example, a reliability of the objects (r) detected only by the radar sensors 16 is lower than a reliability of the objects (f). When the driver relatively strongly operates the accelerator pedal 51 after the PCS control is started to be executed, there may be not actually the objects (r) around the own vehicle VA. Thus, when the condition C2 becomes satisfied, the PCS ECU 10 may stop executing the PCS control.

Further, the stopping condition may include a condition which relates to the brake pedal operation amount BR In this regard, the PCS ECU 10 may be configured to determine that the stopping condition becomes satisfied when the brake pedal operation amount BP becomes greater than or equal to a brake pedal operation amount threshold BPth. When the PCS ECU 10 determines that the stopping condition becomes satisfied in response to the brake pedal operation amount BP becoming greater than or equal to the brake pedal operation amount threshold BPth, the PCS ECU 10 may apply the braking force, depending on the brake pedal operation amount BP, to the wheels of the own vehicle VA.

### Sixth Modified Example

Instead of the radar sensors 16, ultrasonic wave sensors or LIDARs (Light Detection and Ranging/Laser Imaging Detection and Ranging) may be used.

What is claimed is:

1. A vehicle control apparatus, comprising:
at least one surrounding sensor which acquires object information on objects in a surrounding area around an own vehicle;
an operation amount sensor which detects an operation amount of an acceleration operator of the own vehicle;
a steering angle sensor which detects a steering angle of a steering wheel of the own vehicle; and
a control unit which is configured to:
select a control target object, based on the object information; and
execute a collision avoidance control for avoiding a collision of the own vehicle with the control target object when a predetermined execution condition that a probability that the own vehicle collides with the control target object is high, is satisfied,
wherein the control unit is configured to:
determine that a driver of the own vehicle carries out a first mistaken operation when (i) a predetermined first pressing condition that the driver of the own vehicle strongly operates the acceleration operator, is satisfied, and (ii) a magnitude of the steering angle is greater than a predetermined first steering angle threshold; and
permit executing the collision avoidance control when a first situation that (i) the driver of the own vehicle carries out the first mistaken operation, and (ii) a distance between the own vehicle and the control target object is shorter than a predetermined first distance threshold, arises.

2. The vehicle control apparatus as set forth in claim 1, wherein the control unit is configured to forbid accelerating the own vehicle, based on the operation amount when the first situation arises.

3. The vehicle control apparatus as set forth in claim 1, wherein the control unit is configured to determine that the predetermined first pressing condition is satisfied when (i) an operation speed which corresponds to a change amount of the operation amount per unit time is greater than or equal to a predetermined first operation speed threshold, and (ii) the operation amount is greater than or equal to a predetermined first operation amount threshold.

4. The vehicle control apparatus as set forth in claim 1, wherein
the at least one surrounding sensor includes:
a first sensor which takes images of a first area around the own vehicle, acquires image data on the taken images, and acquires the object information on the objects in the first area by using the image data; and
at least one second sensor which acquires the object information on the objects in a second area around the own vehicle by using electromagnetic waves, the second area including the first area and being wider than the first area, and
the control unit is configured to select the control target object from among (i) first objects detected by the first sensor and the at least one second sensor and (ii) second objects detected only by the at least one second sensor when the control unit determines that the driver of the own vehicle carries out the first mistaken operation.

5. The vehicle control apparatus as set forth in claim 1, wherein
the control unit is configured to:
determine that the driver of the own vehicle carries out a second mistaken operation when (i) a predetermined second pressing condition that the driver of the own vehicle strongly operates the acceleration operator, is satisfied, and (ii) the magnitude of the steering angle is smaller than a predetermined second steering angle threshold;
permit executing the collision avoidance control when a second situation that (i) the driver of the own vehicle carries out the second mistaken operation, and (ii) the distance between the own vehicle and the control target object is shorter than a predetermined second distance threshold, arises; and
forbid accelerating the own vehicle, based on the operation amount when the first or second situation arises, and
the predetermined first distance threshold is greater than the predetermined second distance threshold.

6. The vehicle control apparatus as set forth in claim 5, wherein
the control unit is configured to:
determine that the first pressing condition is satisfied when (i) an operation speed which corresponds to a change amount of the operation amount per unit time is greater than or equal to a predetermined first operation speed threshold, and (ii) the operation amount is greater than or equal to a predetermined first operation amount threshold; and
determine that the second pressing condition is satisfied when (i) the operation speed is greater than or equal to a predetermined second operation speed threshold, and (ii) the operation amount is greater than or equal to a predetermined second operation amount threshold, and
the predetermined first operation amount threshold is smaller than the predetermined second operation amount threshold.

7. The vehicle control apparatus as set forth in claim 1, wherein the control unit is configured to stop executing the collision avoidance control when a steering operation speed which corresponds to a change amount of the steering angle per unit time has been greater than a predetermined first steering operation speed for a predetermined time or more.
